(19) United States
(12) Patent Application Publication
(10) Pub. No.: US 2006/0129525 A1
(43) Pub. Date: Jun. 15, 2006

(54) Combined best effort and contention free guaranteed throughput data scheduling

(76) Inventor: Edwin Rijpkema, Nieuwerkerk a/d Ijssel (NL)

Correspondence Address: PHILIPS INTELLECTUAL PROPERTY & STANDARDS, P.O. BOX 3001, BRIARCLIFF MANOR, NY, 10510, US

(21) Appl. No.: 10/538,563

(22) PCT Filed: Nov. 18, 2003
(86) PCT No.: PCT/IB03/05302

§ 371 Date: Jun. 15, 2005

(30) Foreign Application Priority Data
Dec. 19, 2002 (EP) 02080371.4

(51) Int. Cl. G06F 17/30

(52) U.S. Cl. 707/2

(57) ABSTRACT

A data switching device has inputs for Granted Throughput (GT) and Best Effort (BE) data, outputs, a data switch interconnecting the inputs and outputs, (GT) control means for controlling the (GT) data scheduling and (BE) control means for controlling the (BE) data scheduling. The (GT) and (BE) control means are arranged for a combined control such that the (BE) data scheduling is based on a contention free (GT) scheduling.

The present invention relates to a data switching device comprising inputs for guaranteed throughput and best effort data, outputs, a data switch interconnecting the inputs and outputs, guaranteed throughput control means coupled for controlling a guaranteed throughput data scheduling and best effort control means coupled for controlling a best effort data scheduling.

The present invention also relates to a data switching method.

Such a data switching device and method are known from US-2001/0033581 A1. The known data switching device comprises input buffers for data in up to four qualities of service classes. For example there are input buffers belonging to the so called Guaranteed Bandwidth—also called Guaranteed Throughput (GT)—class and the Best Effort (BE) class. The known device further comprises output buffers also for each class separately, a data switch interconnecting the input and output buffers for each and every class, and GT data control means and BE data control means for controlling the GT and BE data scheduling respectively of input data packets. In an embodiment of the known device the control means, apart from conducting a form of priority control for reading order control, conduct a contention control at least for data belonging to the GT class. In a detailed embodiment also meant for carrying out contention control the BE data scheduling is performed after the GT data scheduling, whereby the BE data scheduling is based on input lines and output lines that have not been selected by the scheduling of data packets of the guaranteed bandwidth class. It is a disadvantage of the known data switching device and method that the multiplicity of classes, priorities, input as well as output buffers for each class separately lay a huge burden on the software and processor controlled hardware necessary for controlling, avoiding contention and scheduling the variety of classes of data.

It is an object of the present invention to provide a simplified data switching device and method, which alleviate the burden on required soft- and hardware.

Thereto the switching device according to the invention is characterized in that the guaranteed throughput and best effort control means are arranged for a combined control such that the best effort data scheduling is based on a contention free guaranteed throughput scheduling.

It is an advantage of the switching device and method according to the present invention that it is found that starting from a contention free guaranteed throughput data schedule as a basis for the best effort data scheduling, the guaranteed throughput data schedule simply forms a boundary condition for the best effort data scheduling. This way the guaranteed throughput and best effort scheduling are combined. The border condition then only involves a one step reservation of input and output lines. This saves the burden of hardware and software and control in the data switching device, but also shortens the latency, which is defined as the time a data packet spends in the data switching device. Furthermore no, more or less soft priorities have to be defined and processed, which saves even more software, hardware, and associated control in the data switching device according to the invention.

In an embodiment of the data switching device according to the invention, the data switching device has at least one guaranteed throughput input buffer for at least one data switch input.

This embodiment provides improved flexibility as to the particular choice the numbers of guaranteed throughput input buffers per data switch input(s).

In a further embodiment of the data switching device according to the invention, the at least one guaranteed throughput input buffer is one deep.

The guaranteed throughput data scheduling may be considered as a fixed boundary condition having absolute precedence over the best effort scheduling, without additional waiting. In fact the guaranteed throughput data switching then behaves like a pipelined circuit.

In a further embodiment of the data switching device according to the invention, the data switching device may have one and the same output buffer both for collecting guaranteed throughput and best effort data.

Advantageously no separate input buffers and output buffers are required for both the guaranteed throughput and best effort related data, although both types of data are routed separately through the data switch.

In a further embodiment of the method according to the invention, the best effort scheduling is performed after the guaranteed throughput scheduling.

The scheduling of guaranteed throughput and best effort may be performed sequentially.

Advantageously in a still further embodiment of the method according to the invention the guaranteed throughput data scheduling only takes one step. The one step may even simply involve the reservation of inputs and outputs of the data switch.

In another further embodiment of the method according to the invention, the best effort data scheduling takes one or more multiples of three steps, including the steps: request, grant and accept.

The set of three steps, if repeated one or more times may lead to an improved data scheduling.

It is further advantageous if a contention resolution for said best effort data scheduling is based on for example bipartite graph matching.

At present the data switching device and method according to the invention will be elucidated further together with their additional advantages, while reference is being made to the appended drawing, wherein similar components are being referred to by means of the same reference numerals. In the drawing:

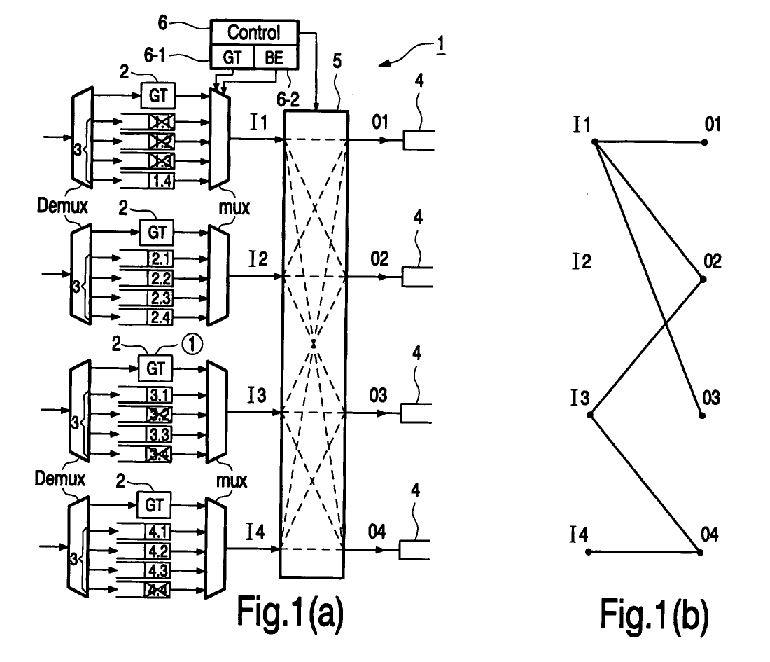

FIG. 1(a) shows an schematic view of a relevant part of the data switching device according to the invention;

FIG. 1(b) shows the relation between inputs and outputs of a data switch for application in the data switching device of FIG. 1(a) in an exemplified so called bipartite graph; and

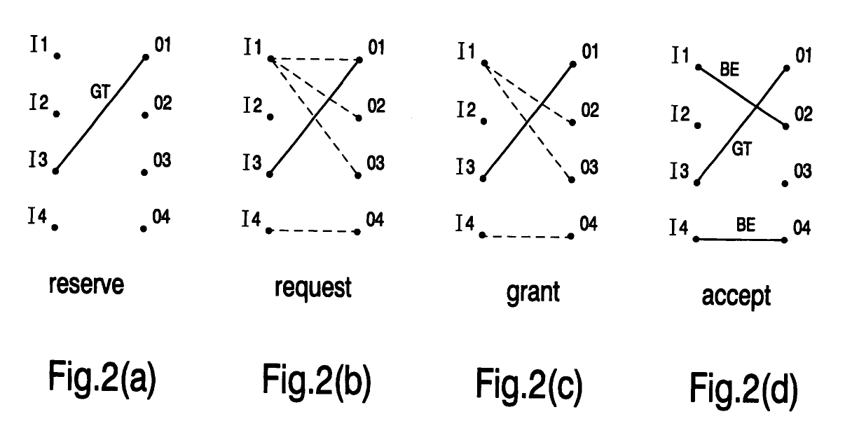

FIGS. 2(a), 2(b), 2(c) and 2(d) shows various phases of the exemplified bipartite graph of FIG. 1(b).

In present day systems-on-chip and network-on-chip architectures there is the challenge of managing the complexity of designing chips containing billions of semiconductor components. Mainly because of costs and bandwidth reasons wires and busses are no longer suitable for dealing with the dynamic communication required in those architectures. Communication services, like for example guaranteed services or Best Effort (BE) services offer an interconnection through a data switching device 1, such as shown in FIG. 1(a). An example of guaranteed services is Guaranteed Throughput hereafter abbreviated to GT, also known as Guaranteed Bandwidth. GT services require resource reservations for worst case communication scenarios, whereas BE services can be used for less critical data communication, but do not provide guarantees in terms of throughput. At the other hand BE data traffic may have a better average communication performance than offered by guaranteed services. Both GT and BE services are required in a present day flexible data switching device 1.

As shown in FIG. 1(a) the data switching device 1 comprises input buffers 2 and 3, and output buffers 4. Input buffers 2 are meant for GT data and input buffers 3 are meant for BE data. In a device (not shown) input data may be separated in GT and BE data. The input buffers 2 and 3 are coupled between schematically shown demultiplexers, indicated DEMUX, and multiplexers, indicated MUX. The data switching device 1 further comprises a data switch 5, also called for example a crossbar switch, router switch or switching matrix, interconnecting the input buffers 2, 3 and output buffers 4. In addition the data switching device I comprises scheduling control means 6, indicated CONTROL coupled to said input buffers 2, 3, and to the output buffers 4, and to the data switch 5. A part of the scheduling control means is GT control means 6-1 for controlling the GT data scheduling of the data switch 5 and another part of the scheduling control means is BE control means 6-2 for controlling the BE data scheduling of the data switch 5. Every time the scheduling results in absence of contention on either the input buffers 2, 3, or the output buffers 4. Contention, refers to the occasion wherein multiple data items simultaneously request a same input I1 . . . I4 (=input contention) or a same output O1 . . O4 (=output contention) of the data switch 5.

Starting point of the GT scheduling is such that it is presupposed that a GT data switching schedule is itself free of contention. Because the scheduling normally involves three phases or steps, which will be elucidated later, that is the request, the grant and the accept step, advantage can be taken from the contention free GT scheduling by the fact that these three steps reduce to one GT reservation step, which precedes the three BE scheduling steps. Thus the GT scheduling followed by the BE scheduling advantageously only takes four steps all together. In particular the GT and BE control means 6-1 and 6-2 are arranged for a combined control such that the BE data scheduling is based on the contention free GT scheduling. This saves both hardware and software scheduling control. Due to the GT being contention free, also at the output O1 . . . O4 and output buffers these output buffers 4 for GT and BE may be one and the same output buffer 4. The GT input buffers may be chosen to be only one deep, which again saves both hardware and software scheduling control, and also minimizes latency of the GT data.

An example will explain the combined or intertwined scheduling of GT and BE. Suppose as exemplified by FIGS. 1(a) and 1(b) for the purpose of this simple example, that the arity of the router switch 5 is four, that is the switch has four inputs, numbered I1 . . . I4 and four outputs, numbered O1 . . . O4. The scheduling is such that the GT control means 6-1 first reserve a GT connection lets say between input I3 and output O1, as shown in FIG. 2(a). A situation indicated by crossed BE input buffers 3, meaning that the buffers 3 are filled with data, as schematically shown in FIG. 1(a), would result in a so called bipartite graph for the BE scheduling as shown in FIG. 1(b). For example 3,2 in input buffer 3 means that a data connection from input I3 to output O2 is wanted. At the side of input I1 three BE input buffers 3 would request data communication to outputs O1, O2 and O3. Input I2 does not show any request. Input I3 would request data communication to outputs O2 and O4, and input I4 only requests data transfer to output O4. Due to the contention free GT scheduled connection—indicated by an encircled 1—any BE request from input I3 to any output is disabled. This means that in the request step the BE requests from input I3 to outputs O2 and O4 are being ignored, which simplifies the BE scheduling, because a smaller amount of inputs have to be taken into account during the BE request phase. The next step is the grant step, wherein first any BE grant from output O1 to any input is disabled, which again simplifies the further BE scheduling, because a smaller amount of outputs have to be taken into account for the BE scheduling during the BE grant phase. The then next step is the BE accept step, where by way of example the data connection between output O2 and input I1 is accepted. Thereafter the actual GT and BE data communication may be effected. The triplet of the steps Request, Grant and Accept may be repeated one or more times, in order to improve the scheduling further.

1. A data switching device comprising inputs for guaranteed throughput and best effort data, outputs, a data switch interconnecting the inputs and outputs, guaranteed throughput control means coupled for controlling a guaranteed throughput data scheduling and best effort control means coupled for controlling a best effort data scheduling, characterized in that the guaranteed throughput and best effort control means are arranged for a combined control such that the best effort data scheduling is based on a contention free guaranteed throughput scheduling.

2. The data switching device according to claim 1, wherein the data switching device has at least one guaranteed throughput input buffer for at least one data switch input.

3. The data switching device according to claim 2, wherein the at least one guaranteed throughput input buffer is one deep.

4. The data switching device according to claim 2, wherein the data switching device has one and the same output buffer both for collecting guaranteed throughput and best effort data.

5. A data switching method, wherein guaranteed throughput and best effort data is scheduled for switching, characterized in that the best effort data scheduling is based on a contention free guaranteed throughput data scheduling.

6. The method according to claim 5, characterized in that the best effort scheduling is performed after the guaranteed throughput scheduling.

7. The method according to claim 5, characterized in that the guaranteed data scheduling takes one step.

8. The method according to claim 7, characterized in that the one step involves a reservation of inputs and/or outputs.

9. The method according to claim 5, wherein the best effort data scheduling takes one or more multiples of three steps, including the steps: request, grant and accept.

10. The method according to claim 9, wherein a contention resolution for said best effort data scheduling is based on bipartite graph matching.
